(19) United States
(12) Patent Application Publication
(10) Pub. No.: US 2015/0160933 A1
(43) Pub. Date: Jun. 11, 2015

(54) CPU COMPILER CONFIGURATION FOR LOW POWER APPLICATIONS

(71) Applicant: Texas Instruments Deutschland GMBH, Freising (DE)

(72) Inventor: Thomas Mitnacht, Muenchen Bayern (DE)

(21) Appl. No.: 14/101,825

(22) Filed: Dec. 10, 2013

(51) Int. Cl. G06F 9/45

(52) U.S. Cl. CPC G06F 8/4432

(57) ABSTRACT

In an embodiment of the invention, a compiler is configured to provide a low-power application by first compiling the application settings to optimize for size, running it on a CPU and obtaining power measurements for a number of the functions in the application. From the power measurements, a set of functions is identified that uses the majority of power. Next the complier is set to maximize the speed for this set of functions and the application is recompiled. After recompiling, the application is run again on the CPU and power is measured again. The above method may be repeated to obtain lower power.

### BACKGROUND

For low power applications a proper configuration of the CPU compiler (code generation tools) setting is important. Compiler settings can influence the application runtime behavior significantly depending on the compiler options used. Typically an application may be compiled for speed or size depending on the preferred user setting. Optimizing for size will create a smaller application but typically will lead to a longer run-time. Optimizing for speed will create an application that runs faster but the application size will increase. A faster running application usually requires less time to execute and therefor requires less overall power.

Individual functions in an application may also be measured for power consumption. Hence if a user knows how much power each individual function uses in the application, the overall power consumption can be optimized more efficiently for lower power consumption without increasing the application size a great deal. An embodiment of the invention describes how compiler settings may be derived from data extracted by EnergyTrace (U.S. patent application Ser. No. 13/329,073) and be passed to the compiler.

### BRIEF DESCRIPTION OF THE DRAWINGS

FIG. 1 is a flow diagram illustrating a method of using power measurements to configure a compiler for low power applications according to an embodiment of the invention.

### DETAILED DESCRIPTION

In an embodiment of the invention a compiler may be configured to provide a low-power application by first compiling the application settings that optimize for size of the application and running it on a CPU. While the CPU is running, power measurements are obtained for a number of the functions in the application. One tool that may be used to obtain these power measurements is EnergyTrace. Energy Trace provides runtime data of the application power consumption. After the power measurements are obtained, the application is stopped from running on the CPU. From the power measurements, a set of functions used in the application are identified as using the majority of power on the application.

Next the complier is set to maximize the speed of the set of functions. After setting the compiler settings, the application is recompiled. After recompiling, the application is run on the CPU. While the application is being run on the CPU, power is measured again. After the power is measured, the application is stopped from running and the power from rerun is reported. The power may be reported using a graphical user interface (GUI). The above method may be repeated to obtain even lower power usage.

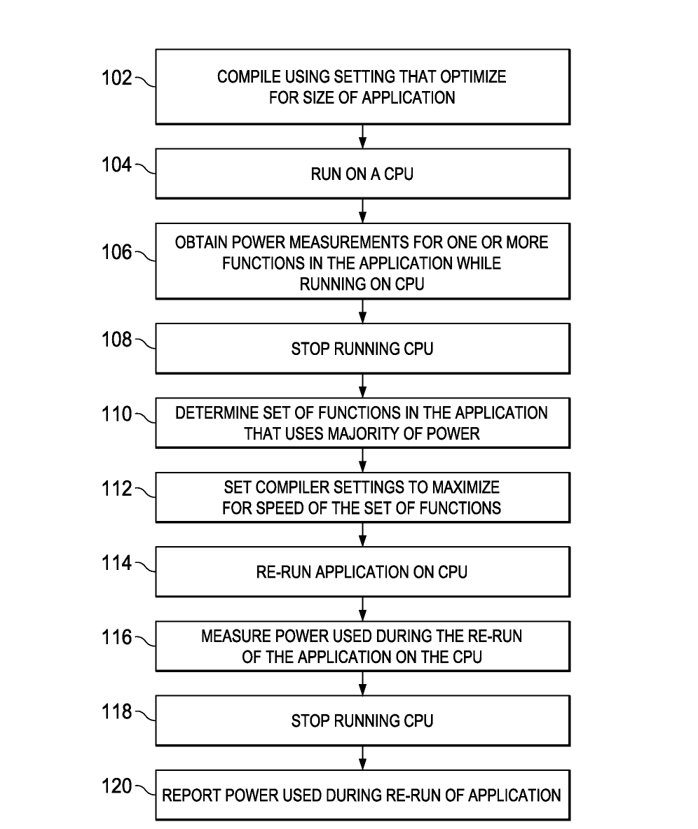

FIG. 1 is a flow diagram illustrating a method of using power measurements to configure a compiler for low power applications according to an embodiment of the invention. At step 102 the application is compiled to optimize for the size of the application. At step 104 the application is run on a CPU. During step 106 power is measured for one or more functions used in the application while the application is running on the CPU and then the CPU is stopped at step 108. At step 110 a set of functions in the application that use the majority of the power is determined. Next during step 112 the compiler setting are set to maximize the speed of the set of functions and the application is run again on the CPU at step 114. At step 116 power is measured during the rerun of the application on the CPU and the running of the CPU is stopped at step 118. At step 120 the power used in the rerun is reported. If the measured is not low enough, the process may begin again at step 102.

What is claimed is:

1. A method for configuring a compiler to provide a low-power application comprising:
compile the application using settings that optimize for size of the application;
run the application on a CPU;
obtain power measurements for one or more functions in the application while the application is running on the CPU;
stop running the application on the CPU;
determine a set of functions from the one or more functions in the application wherein the set of functions is using a majority of power used in the application;
set the complier settings for the set of functions to maximize speed;
recompile the application using the complier settings for maximum speed;
rerun the application on the CPU using the complier settings for maximum speed;
measure power used during the rerun of the application on the CPU;
stop running the application on the CPU;
report the power used during the rerun of the application on the CPU.

2. The method of claim 1 wherein the power measurements are obtained by Energy Trace.

3. The method of claim 1 wherein the report is generated using a graphical user interface.
